(19) United States
(12) Patent Application Publication
(10) Pub. No.: US 2017/0360214 A1
(43) Pub. Date: Dec. 21, 2017

(54) Multi-Purpose Towel Including a Mechanism for Coupling to a Seat

(71) Applicant: Jerry Jensen, Austin, TX (US)

(72) Inventor: Jerry Jensen, Austin, TX (US)

(21) Appl. No.: 15/627,355

(22) Filed: Jun. 19, 2017

Related U.S. Application Data
(60) Provisional application No. 62/352,322, filed on Jun. 20, 2016.

(51) Int. Cl. A47C 31/11; A47K 10/02; B60N 2/60

(52) U.S. Cl. CPC A47C 31/113; B60N 2/6027; A47K 10/02; B60N 2/6009

(57) ABSTRACT

In certain embodiments, a multi-purpose towel may include a body portion including an absorbent material and a hood portion coupled to the body portion. The hood portion may define a channel. The multi-purpose towel may further include at least one drawstring extending through the channel and including a first end portion and a second end portion. The multi-purpose towel may also include a first coupling mechanism coupled to the first end portion and a second coupling mechanism coupled to the second end portion.

### CROSS-REFERENCE TO RELATED APPLICATION(S)

The present disclosure is a non-provisional patent application of and claims priority to U.S. Provisional Patent Application No. 62/352,322 filed on Jun. 20, 2016 and entitled “Multi-Purpose Towel Including a Drawstring with Coupling Mechanisms”, which is incorporated herein by reference in its entirety.

### FIELD

The present disclosure is generally related to a multi-purpose towel including a drawstring with coupling mechanisms, and more particularly to a towel including a hood portion and including a drawstring with coupling mechanisms to facilitate attachment to secure the towel to an object, such as a chair, a car seat, a lawn chair, and the like.

### BACKGROUND

Activities, such as swimming, running, sporting events, or other events, may cause a person's clothing to be wet. To protect car seat after such activities, individuals may place a towel or other cover over a car seat, for example. Further, in some examples, an individual may want to cover a pool-side chair or other seat, either to provide a buffer from the heated surface or to provide a more comfortable surface on which to sit or lie down.

### SUMMARY

In certain embodiments, a multi-purpose towel is described that can include a hood portion, a body portion, and at least one drawstring configured to couple the multi-purpose towel to an object, such as a chair or a car seat, or to secure the towel to a user. In some embodiments, the drawstring makes it possible to tighten the hood over a head rest of a seat so that the towel remains stationary during use. In some embodiments, eyelets may be provided in the hood, which may facilitate a smooth attachment to a seat with no head rest, such as by pulling the hood down and extending the drawstring through the eyelets to secure the towel to the seat. Other embodiments are also possible.

In certain aspects, each of the first coupling mechanism and the second coupling mechanism may include a tab forming a substrate and at least one opening configured to receive an end portion of the drawstring. In some aspects, the tab may be formed from at least one of metal, wood, plastic, and closed-cell resin material.

In some aspects, at least one magnet coupled to the tab. In some other aspects, a metallic element may be coupled to the tab at a first location, and a magnet may be coupled to the tab at a second location spaced apart from the first location. In some embodiments, the tab and a portion of the end portion of the drawstring may cooperate to form a cinch.

### BRIEF DESCRIPTION OF THE DRAWINGS

FIG. 1A depicts a perspective view of a conventional seat with a headrest to which a multi-purpose towel may be attached, in accordance with certain embodiments of the present disclosure.

FIG. 1B depicts a perspective view of the seat of FIG. 1A covered by the multi-purpose towel, in accordance with certain embodiments of the present disclosure.

FIG. 1C depicts a rear view of the seat of FIG. 1B and including the multi-purpose towel, in accordance with certain embodiments of the present disclosure.

FIG. 2A depicts a perspective view of a poolside chair without a headrest to which the multi-purpose towel may be attached, in accordance with certain embodiments of the present disclosure.

FIG. 2B depicts a perspective view of the poolside chair of FIG. 2A covered by the multi-purpose towel, in accordance with certain embodiments of the present disclosure.

FIG. 2C depicts a rear view of the chair of FIG. 2B and including the multi-purpose towel, in accordance with certain embodiments of the present disclosure.

FIG. 3 depicts a multi-purpose towel, in accordance with certain embodiments of the present disclosure.

FIG. 4A depicts a top view of a coupling mechanism configured to releasably couple together ends of a drawstring of the multi-purpose towel, in accordance with certain embodiments of the present disclosure.

FIG. 4B depicts a cross-sectional view of the coupling mechanism of FIG. 4A, in accordance with certain embodiments of the present disclosure.

FIG. 4C depicts a perspective view of the coupling mechanism of FIGS. 4A and 4B and including an end portion of a drawstring, in accordance with certain embodiments of the present disclosure.

FIG. 5A illustrates a perspective view of the coupling mechanism of FIG. 4C including an expanded gap between the end portion of the drawstring and the tab portion forming a loop, in accordance with certain embodiments of the present disclosure.

FIG. 5B illustrates a perspective view of a pair of coupling mechanisms coupled together to secure the drawstring, in accordance with certain embodiments of the present disclosure.

FIG. 6A depicts a block diagram view of a pair of magnets configured to form the coupling mechanisms, in accordance with certain embodiments of the present disclosure.

FIG. 6B depicts a cross-sectional view of a tab portion including the pair of magnets within a coupling mechanism, in accordance with certain embodiments of the present disclosure.

FIG. 6C depicts a cross-sectional view of a pair of tab portions of FIG. 4B coupled together magnetically, in accordance with certain embodiments of the present disclosure.

FIG. 7A depicts a block diagram view of a magnet and a metallic element forming the coupling mechanisms, in accordance with certain embodiments of the present disclosure.

FIG. 7B depicts a cross-sectional view of a tab portion including a magnet and a metallic element to form a coupling mechanism, in accordance with certain embodiments of the present disclosure.

FIG. 7C depicts a cross-sectional view of a pair of tab portions of FIG. 7B coupled together magnetically, in accordance with certain embodiments of the present disclosure.

FIG. 8A depicts a front perspective view of a multi-purpose towel coupled to a car seat, in accordance with certain embodiments of the present disclosure.

FIG. 8B depicts a rear perspective view of a multi-purpose towel coupled to the car seat of FIG. 8A.

FIG. 9 depicts a multi-purpose towel, in accordance with certain embodiments of the present disclosure.

FIG. 10 depicts a multi-purpose towel, in accordance with certain embodiments of the present disclosure.

FIG. 11 depicts a multi-purpose towel including eyelets in a hood portion and including drawstrings, in accordance with certain embodiments of the present disclosure.

FIG. 12A illustrates a multi-purpose towel coupled to a bench seat, in accordance with certain embodiments of the present disclosure.

FIG. 12B depicts the multi-purpose towel of FIG. 11 folded in half lengthwise and depicting one of the eyelets, in accordance with certain embodiments of the present disclosure.

FIG. 12C depicts a fastener coupled to a loop formed from a drawstring, in accordance with certain embodiments of the present disclosure.

FIG. 13 illustrates a flow diagram of a method of coupling a multi-purpose towel to a seat, in accordance with certain embodiments of the present disclosure.

FIG. 14 depicts a flow diagram of a method of forming a multi-purpose towel, in accordance with certain embodiments of the present disclosure.

FIG. 15A depicts a front perspective view of a multi-purpose towel coupled to a seat without a head rest, in accordance with certain embodiments of the present disclosure.

FIG. 15B depicts a rear perspective view of the seat and multi-purpose towel of FIG. 15A.

FIG. 16 depicts a flow diagram of a method of coupling a multi-purpose towel to a seat without a head rest, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of a multi-purpose towel and associated methods of releasably securing the towel to an object or to a user are described below. In some embodiments, the multi-purpose towel may include a body portion and a hood portion. In some examples, the hood portion may be sized to fit over a user's head so that the towel may be worn. The hood portion may also fit over a head rest of a seat, such as an office chair or a car seat. The hood portion may include a drawstring that can be used to tighten the hood portion. Further, the drawstring may include one or more coupling mechanisms (such as fasteners, buttons, or tabs) at the ends of the drawstring. The coupling mechanisms may be configured to couple to one another to secure the drawstring in a cinched state.

In some embodiments, the hood portion of the multi-purpose towel may include one or more eyelets or button holes. In such embodiments, the coupling mechanisms at the ends of the drawstring may be pushed through one or more of the eyelets to secure the multi-purpose towel by holding the drawstring in a cinched state. The coupling mechanisms at the end of the drawstring may fit through the eyelet like a button. In a particular embodiment, the eyelets may be located adjacent to an apex or top portion and near a center of the multi-purpose towel, and the eyelets may cooperate with the drawstrings and coupling mechanisms to pull the hood portion down to provide a smooth appearance when coupled to a seat with no headrest. Additionally, in some embodiments, the drawstring may be formed from an elastic cord or string, which may be stretched and which may retract to secure the towel.

In certain embodiments, the coupling mechanisms may be formed from magnets, from a magnet and a metallic element, from plastic clips, a button-like element, or another coupling element. In certain embodiments, the coupling mechanism may be formed from tab elements, where each tab element may include a pair of holes to couple to the drawstring. In some embodiments, the drawstring may extend through one opening and through the other opening, and the end of the drawstring may be tied to or otherwise coupled to a portion of the drawstring to form a loop. In a particular embodiment, the end may be coupled to the portion of the drawstring by a shrink wrap material, an adhesive material, metallic crimp, another material, or any combination thereof. In certain embodiments, the loop may be used as a cinch or as an eyelet that can receive and secure a coupling mechanism of the other end of the drawstring. Other embodiments are also possible.

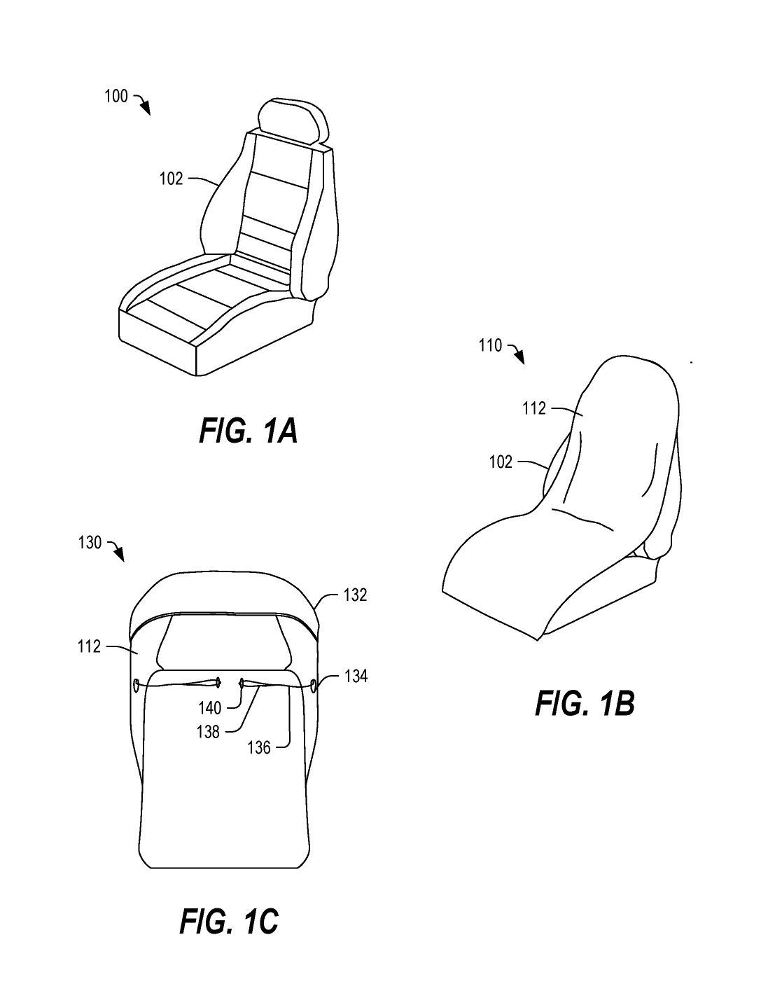

FIG. 1A depicts a perspective view 100 of a conventional seat 102 with a headrest to which a multi-purpose towel may be attached, in accordance with certain embodiments of the present disclosure. The seat 102 is an example of a car seat. Other embodiments of seats, such as office chairs, reclining chairs, table chairs, other types of chairs, or any combination thereof.

In certain embodiments, a user may be wet or otherwise dirty and may have dirt or other material on his or her clothes. In some embodiments, a multi-purpose towel may be fastened to the seat 102 to protect the seat 102. An example of such an arrangement is described below with respect to FIGS. 1B and 1C.

FIG. 1B depicts a perspective view 110 of the seat 102 of FIG. 1A covered by the multi-purpose towel 112, in accordance with certain embodiments of the present disclosure. In this example, the multi-purpose towel 112 may include a hood portion that can be extended over the headrest of the seat 102. Further, the multi-purpose towel 112 may include one or more drawstrings that can be tightened to secure the multi-purpose towel 112 to the seat 102.

FIG. 1C depicts a rear view 130 of the seat 102 of FIG. 1B and including the multi-propose towel 112, in accordance with certain embodiments of the present disclosure. A hood portion 132 of the towel 112 is extended over the headrest. At least one end of a drawstring 136 may extend through an opening 134 and can be pulled to tighten the hood portion 132 over the headrest. The drawstring 136 may be fed through a coupling element 140 and attached to itself to form a loop 138. A second portion of the drawstring may extend through a corresponding hole on an opposite side and the drawstring ends may fastened to one another to secure the towel 112.

It should be appreciated that the carseat is one possible example of a seat on which the multi-purpose towel 112 may be used. Other chairs are also possible. Further, while the illustrated example of FIG. 1 depicts a seat with a headrest, the towel may also be used with chairs or seats that do not have a headrest. Other embodiments are also possible.

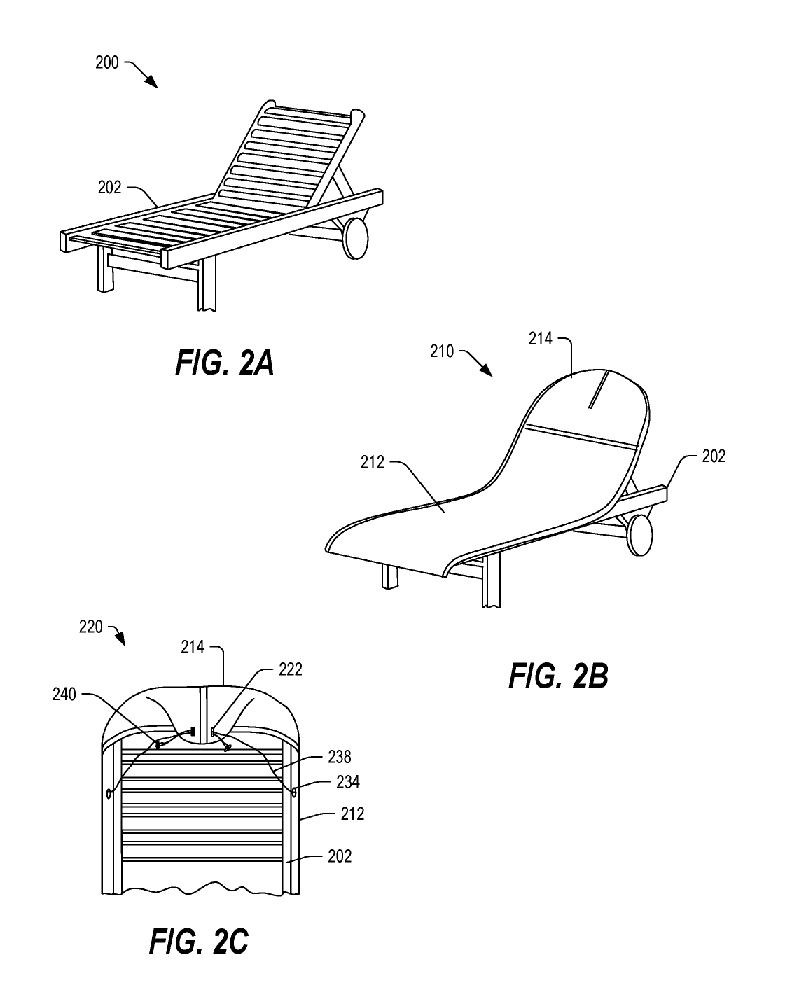

FIG. 2A depicts a perspective view 200 of a poolside chair 202 without a headrest to which the multi-purpose towel, such as the multi-purpose towel 112 of FIG. 1, may be attached, in accordance with certain embodiments of the present disclosure.

FIG. 2B depicts a perspective view 210 of the poolside chair 202 of FIG. 2A covered by the multi-purpose towel 212, in accordance with certain embodiments of the present disclosure. The multi-purpose towel 212 may be an embodiment of the multi-purpose towel 112 in FIG. 1. The towel 212 may be placed onto the poolside chair 202 such that the hood portion 214 fits over a head portion of the chair 202.

FIG. 2C depicts a rear view 220 of the chair 202 of FIG. 2B and including the multi-purpose towel 212, in accordance with certain embodiments of the present disclosure. The hood portion 214 of the towel 212 may extend over an end of the chair 202. In this embodiment, the hood portion 214 of the towel 202 may include openings, such as an opening 234 from which a drawstring 238 may extend. The drawstring 238 may be coupled to a coupling mechanism 240, such as a button or tab, which may be threaded through slits or button holes 222 on the hood portion 214.

In some embodiments, the drawstring 238 may be pulled to apply a hoop stress to the hood portion 214 to secure the towel 212 to the chair 202. Further, the slits or button holes 222 may cooperate with the coupling mechanism 240 to secure the hood 214 by receiving the drawstring 238 and the coupling mechanism 240 and by engaging the coupling mechanism 240 to prevent the drawstring 238 from being withdrawn. In some embodiments, the drawstring 238 may be formed from an elastic cord or other elastic material, which may retract to maintain the drawstring 238 in tension to hold the hood portion 214 down. Further, the embodiment described with respect to FIG. 2C may provide a smooth profile for seats that do not have a headrest.

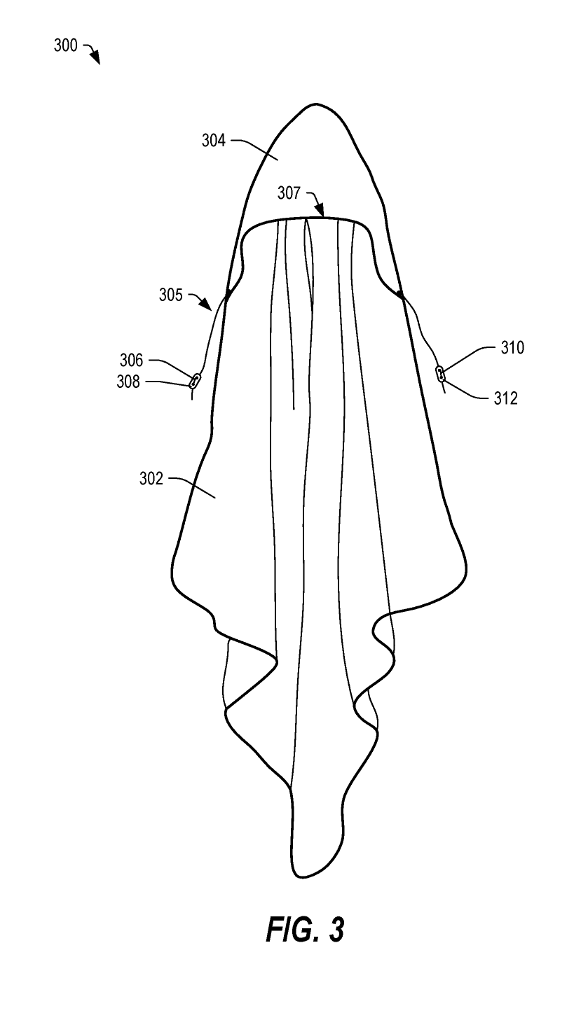

FIG. 3 depicts a view 300 of a multi-purpose towel 112, in accordance with certain embodiments of the present disclosure. The multi-purpose towel 112 may include a body portion 302 and a hood portion 304. In some embodiments, the body portion 302 and the hood portion 304 may be formed from a unitary piece of material, such as a rectangular towel, and the end of the towel may be sewn to form the hood portion 304.

In some embodiments, the body portion 302 and the hood portion 304 may be formed from different materials. In other embodiments, the body portion 302 and the hood portion 304 may be formed from the same material. In certain embodiments, the body portion 302 and the hood portion 304 may be formed from one or more layers of material, such as a terry cloth material, another moisture-absorbent material, a moisture-wicking material, another layer of material, or any combination thereof. In some embodiments, the body portion 302 and the hood portion 304 may include different numbers of layers, different combinations of materials, or any combination thereof.

The multi-purpose towel 112 may further include a drawstring, generally indicated at 305. The drawstring 305 may extend through openings along an edge of the hood portion and through a channel that is formed along a peripheral edge 307 of the hood portion 304. The drawstring 305 may include a first end portion including a first coupling mechanism 308 and may include a second end portion including a second coupling mechanism 312. It should be appreciated that the terms “first” and “second” in the discussion are intended to clarify the various elements and to not indicate any particular order. In some embodiments, the drawstring 305 may be formed from a thin woven yarn or string-like material, rope, cord, or other material. In certain embodiments, the drawstring 105 may be formed from an elastic cord. Other embodiments are also possible.

The coupling mechanisms 308 and 312 may be formed from a variety of materials and may have different structures, depending on the implementation. In the illustrated example, the coupling mechanisms 308 and 312 are formed as tabs, buttons, or substrates, each of which includes a pair of holes to receive the end of the drawstring 305. In this example, the first end portion of the drawstring 305 can form an adjustable loop or cinch 306 relative to the substrate through which the other coupling mechanism may be passed (e.g., between the loop or cinch 306 and the surface of the coupling mechanism 308). Similarly, the other end of the drawstring 305 may form a loop or cinch 310 relative to the coupling mechanism 312. The drawstring 305 may then be pulled tight through the holes of the tab or substrate to reduce the size of the loop or cinch 306 to secure the coupling mechanism 308 and 312 together.

In some embodiments, both of the coupling mechanisms 308 and 312 may include a magnet. In some embodiments, one of the coupling mechanisms may include a magnet, and the other coupling mechanism may include a metallic element that is attracted to the magnetic field produced by the magnet. In still other embodiments, one or both of the coupling mechanisms may include a clip, clasp, or snap-fit type of element configured to engage a corresponding feature of the other coupling mechanism. Other embodiments are also possible.

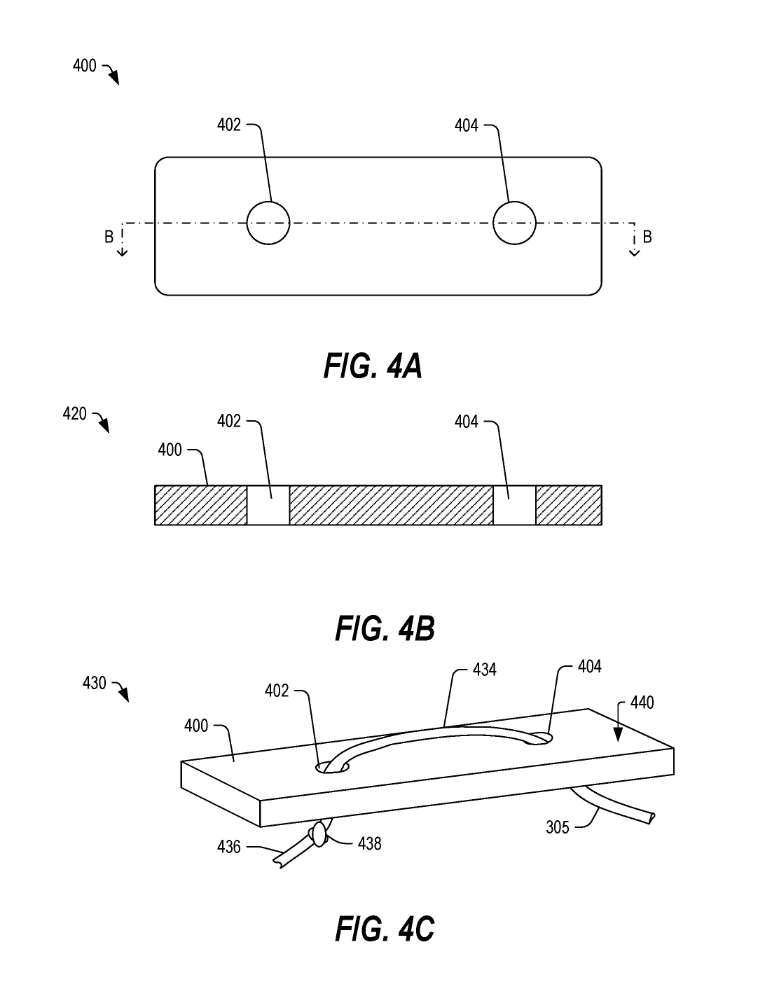

FIG. 4A depicts a top view of a coupling mechanism 400 configured to releasably couple together ends of the drawstring 305 of the multi-purpose towel 100, in accordance with certain embodiments of the present disclosure. The coupling mechanism 400 may be an embodiment of the coupling mechanisms 308 and 312 in FIG. 3. In the illustrated example, the coupling mechanism 400 may include a first opening 402 and a second opening 404, which may be sized to receive ends of the drawstring 305.

In an example, an end portion of the drawstring 305 may be threaded through the first opening 402 and then through the second opening 404. In some embodiments, a knot may be tied in the end portion after it is threaded through the second opening 404 to prevent the tab 400 from slipping from the end portion of the drawstring 305. In some embodiments, an end of the drawstring, after threading through the first and second openings 402 and 404, may be coupled to itself to form a loop, using a knot, an adhesive attachment element, a shrink wrap type of attachment element, a crimp element, another attachment element, or any combination thereof. In an alternative embodiment, a fastener may be connected to the end of the end portion 306 to prevent the end portion 306 from being withdrawn through the openings 404 and 402. Other embodiments are also possible.

In the illustrated example of FIG. 4A, the coupling mechanism 400 has a substantially rectangular shape with rounded corners. The coupling mechanism 400 may be formed from other shapes, such as a diamond shape, a rectangular shape, an elliptical shape, a circular shape, or another shape.

FIG. 4B depicts a cross-sectional view 420 of the coupling mechanism 400 of FIG. 4A, in accordance with certain embodiments of the present disclosure. The coupling mechanism 400 may be formed from a rigid material, such as wood, metal, or plastic. Alternatively, the coupling mechanism 400 may be formed from a lightweight material, such as sealed cardboard or cardstock, a closed-cell resin, rubber, or other material that may be partially flexible. One possible example of a closed-cell resin may be similar to the closed-cell resin called Croslite™, which is a proprietary material used by Crocs of Niwot, Colo. Other types of material may also be used.

The openings 402 and 404 extend entirely through the tab 402 substantially perpendicular to a longitudinal surface of the tab 402. In an alternative embodiment, a single opening may be provided, extending from one end to another end of the tab 400, allowing the drawstring to extend through the tab 402. Other embodiments are also possible.

FIG. 4C depicts a perspective view 430 of the coupling mechanism 200 of FIGS. 4A and 4B and including an end portion of the drawstring 305, in accordance with certain embodiments of the present disclosure. In the illustrated example, the end portion of the drawstring 305 may be threaded through the opening 404 from a first side to a second side of the tab 400. The end portion may then be threaded through the opening 402 from the second side to the first side of the tab 400. In an alternative example, the drawstring 305 may be threaded through the first opening 402 and then through the second opening 404.

In certain embodiments, the end portion of the drawstring 305 may be secured to the tab 400 by forming a knot 438 near the end 436 on the first side of the tab 400 near the opening 402. In an alternative embodiment, a fastener, clip or other device may be coupled to or near the end 436. The knot 438 (or other device) may prevent the drawstring 305 from being withdrawn through the opening 402 and may secure the tab 400 to the drawstring 305. In an alternative embodiment, the end 436 may be secured to the drawstring 305 to form a loop.

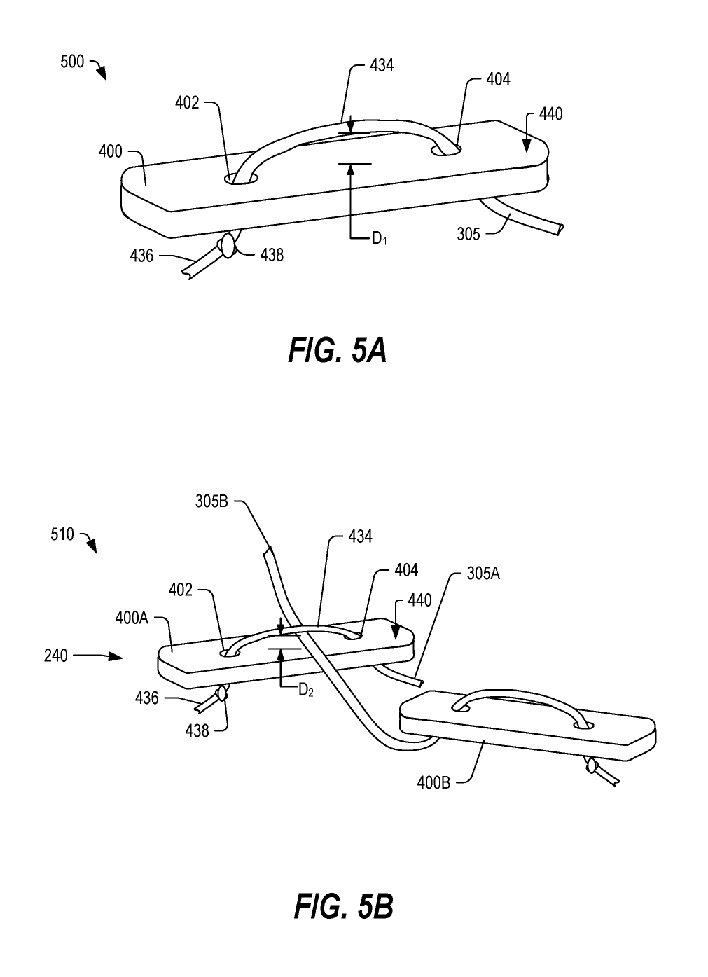

In certain embodiments, a portion 434 of the drawstring 305 may form a cinch or adjustable loop relative to a surface 440 of the tab 400. The loop may be expanded by pulling on the portion 434 and may be closed or cinched by pulling on the drawstring 305. In some embodiments, the adjustable loop and the coupling mechanism (or tab) 400 cooperate to form a cinch that may be used to secure a corresponding coupling mechanism 400, as described below with respect to FIGS. 5A and 5B.

FIG. 5A illustrates a perspective view 500 of the coupling mechanism 400 of FIGS. 4A-4C including an expanded gap (D₁) between the portion 434 of the drawstring 305 and the surface of the tab 400 forming a loop, in accordance with certain embodiments of the present disclosure. In the illustrated example, the portion 434 may be adjusted to expand the loop relative to the surface of the coupling mechanism 400. A corresponding coupling mechanism 400 may be extended through the loop between the portion 434 and the surface 440 of the coupling mechanism 400. The drawstring 305 may then be pulled to adjust the cinch and to secure the coupling mechanism 400B to the coupling mechanism 400A. An example of such a coupling is described below with respect to FIG. 5B.

FIG. 5B illustrates a perspective view 510 of a pair of coupling mechanisms 400A and 400B are coupled together to secure the end portions 105A and 305B of the drawstring 305, in accordance with certain embodiments of the present disclosure. In the illustrated example, the coupling mechanism 400B has been inserted through the loop formed by the portion 434 and the surface 440 of the tab 400A, and the drawstring 305A has been pulled to cinch the loop. By cinching the loop, the portion 434 and the tab 400A cooperate to secure the coupling mechanism 400B.

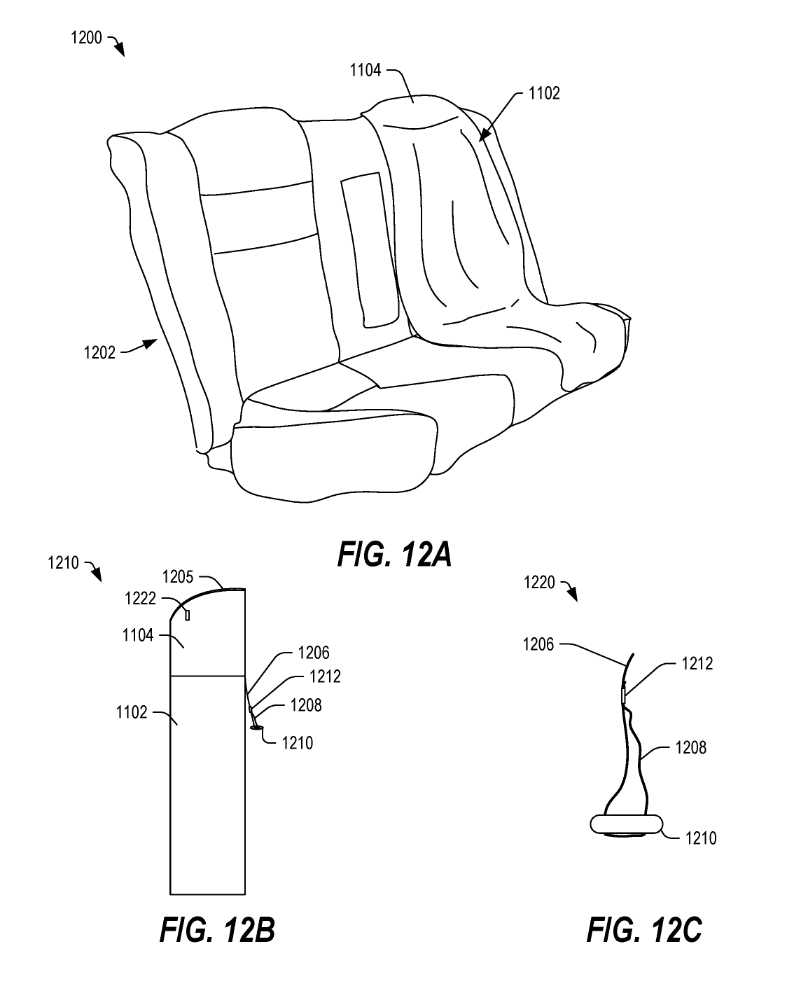

It should be appreciated that the cinch-type coupling is one possible example of a coupling mechanism. In another embodiment, magnets, clips or other attachment features may be used to secure the coupling mechanism 400A to the coupling mechanism 400B. In still another embodiment, as depicted below in FIG. 12C, the coupling mechanism may be implemented as a loop where the end of the drawstring is coupled to the drawstring by tape, glue, a shrink attachment, or any combination thereof to form the loop. Other embodiments are also possible, as described below.

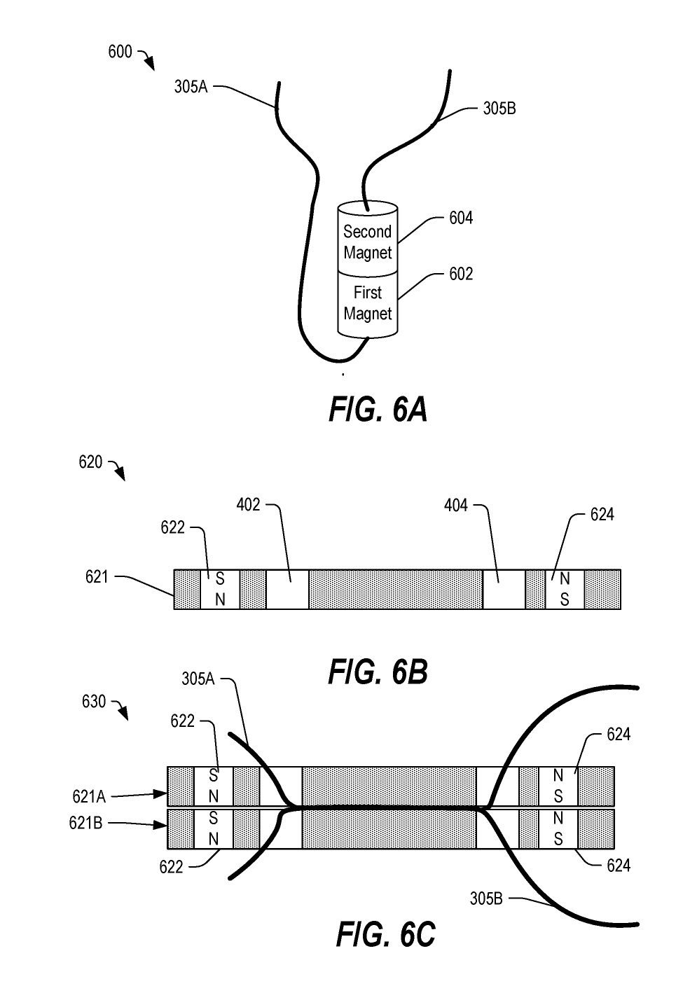

FIG. 6A depicts a block diagram view 600 of a pair of magnets 602 and 604 configured to form the coupling mechanisms, in accordance with certain embodiments of the present disclosure. In some embodiments, the magnets 602 and 604 may be embedded within the coupling mechanism 400 of FIGS. 4A through 5B. Other embodiments are also possible.

In an example, a first magnet 602 may be coupled to an end of the drawstring 305A, and a second magnet 604 may be coupled to an end of the drawstring 305B. The ends of the drawstring 305A and 305B may be ends of the drawstring 305. In an example, the first end portion and the second end portion may be drawn toward one another (or one may be drawn toward the other), and the magnetic fields of the first and second magnets 602 and 604 may attract one another to form a coupling attachment.

FIG. 6B depicts a cross-sectional view 620 of a coupling mechanism 621 including a pair of magnets 622 and 624 within the coupling mechanism 621, in accordance with certain embodiments of the present disclosure. The tab portion 602 may include a first opening 402 and a second opening 404 and may include a first magnet 622 and a second magnet 624 embedded within the coupling mechanism 621. In the illustrated example, the first magnet 622 and the second magnet 624 may be oriented opposite to one another, such that the first magnet 622 is oriented south/north and the second magnet 624 is oriented north/south. In another embodiment, the first magnet 622 and the second magnet 624 may be oriented in the same direction. Other embodiments are also possible.

FIG. 6C depicts a cross-sectional view 630 of a pair of coupling mechanisms 621 of FIG. 6B coupled together magnetically, in accordance with certain embodiments of the present disclosure. In this example, a first end portion of the drawstring 305A may be extended through openings 402 and 404 in the coupling mechanism 621A, and a second end portion of the drawstring 305B may be extend through openings in the coupling mechanism 621B. In some embodiments, the coupling mechanism 621A may be an embodiment of the coupling mechanisms 308 and 312 in FIG. 3, and the coupling mechanism 621B may be an embodiment of the coupling mechanisms 308 and 312 in FIG. 3. In this example, the magnets 622 and 624 may align to one another to secure the coupling mechanisms 621A and 621B to one another. In another embodiment, the magnet 622 of coupling mechanism 621A may be magnetically coupled to the magnet 624 of coupling mechanism 621B, or vice versa. Other embodiments and other magnetic couplings are also possible.

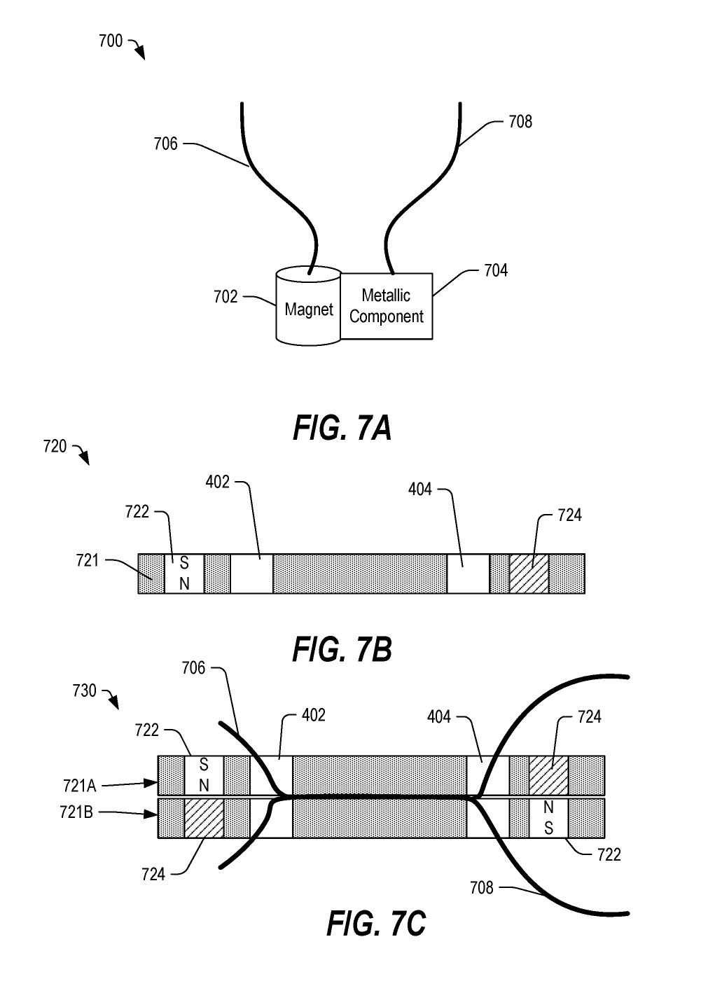

FIG. 7A depicts a block diagram view 700 of a magnet 702 and a metallic component 704 coupled to form a magnetic attachment, in accordance with certain embodiments of the present disclosure. In this example, the first end portion 706 of the drawstring 305 may be coupled to the magnet 702, and the second end portion 708 of the drawstring 305 may be coupled to the metallic component 704 to form the magnetic attachment. The magnet 702 may attract the metallic component 704 to secure the end portions 706 and 708 of the drawstring 305.

FIG. 7B depicts a cross-sectional view of a coupling mechanism 721 including a magnet 722 and a metallic element 724, in accordance with certain embodiments of the present disclosure. The coupling mechanism 721 may include openings 402 and 404 to secure the drawstring 305. Further, the coupling mechanism 721 may secure a magnet 722 and a metallic element 724. In some embodiments, the magnet 722 may attract a metallic element 724 of an adjacent tab 721, as shown in FIG. 7C.

FIG. 7C depicts a cross-sectional view 730 of a pair of coupling mechanisms 721A and 721B coupled together magnetically, in accordance with certain embodiments of the present disclosure. A coupling mechanism 721A may include openings 402 and 404 through which the first end portion 706 of the drawstring 305 may extend. Further, the coupling mechanism 721A may include a magnet 722 and a metallic element 724. A second coupling mechanism 721B may include openings 402 and 404 through which the second end portion 708 of the drawstring 305 may extend. The second coupling mechanism 721B may include a magnet 722 and a metallic element 724.

In the illustrated example, the metallic element 724 of the second coupling mechanism 721B may be coupled to the magnet 722 of the first coupling mechanism 721A. Further, the magnet 722 of the second coupling mechanism 721B may be coupled to the metallic element 724 of the first coupling mechanism 721A. In another example, a clip or buckle could be used to couple the first end portion 706 and the second end portion 708. Other embodiments are also possible.

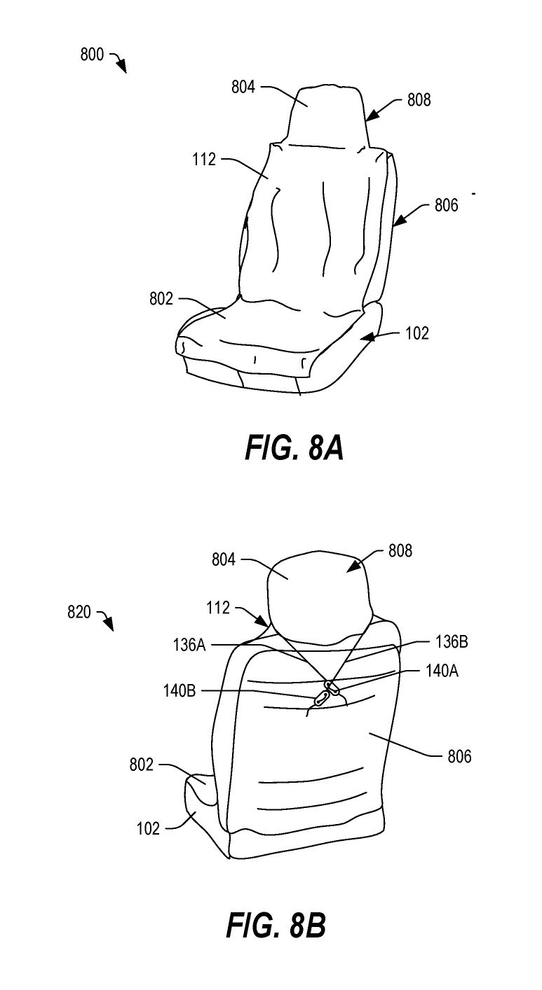

FIG. 8A depicts a front perspective view 800 of a multi-purpose towel 112 coupled to a car seat 802, in accordance with certain embodiments of the present disclosure. The towel 112 may include a body portion 802 and a hood portion 804. In this example, the hood portion 804 may be positioned over a headrest 808 of the car seat 102, and the body portion 802 may be draped over the back 806 of the car seat 102.

In certain embodiments, a first end portion of the drawstring 305 and the second end portion of the drawstring 305 may be pulled to tighten the hood portion 804 about the headrest 808. In an example, the drawstring 305 may apply a “hoop” stress to the surface of the headrest 808 to secure the towel 112 to the car seat 102. By tightening the hood portion 804 to the headrest 808, the towel 112 may be secured to the car seat 102 so that a user can sit down and get back up without displacing the towel 112. The coupling mechanisms may cooperate to secure the drawstring 305 to maintain the hood portion 804 tightened about the headrest 808.

FIG. 8B depicts a rear perspective view 820 of a multi-purpose towel 112 coupled to the car seat 802 of FIG. 8A. In the illustrated example, the coupling elements 140A and 140B may be configured as described above with respect to any of the FIGS. 1-8A. In the illustrated example, the coupling mechanism 140B may be threaded between the portion 434 of the drawstring 305 (in FIG. 4C) and the surface 440 of the coupling mechanism 140A and the drawstring 305 may be tightened to secure the drawstring 305.

In some embodiments, the drawstring may be formed from an elastic cord. The elastic cord may extend to tighten the hood portion 904 about the head rest 808 and may retract to maintain the hood portion 904 in a tightened state. Other embodiments are also possible.

In an alternative embodiment, the coupling mechanisms 140A and 140B may be replaced with a magnetic coupling mechanism, a magnetic/metal coupling mechanism, a clip, a clasp, a buckle, another coupling mechanism, or any combination thereof. In certain embodiments, the coupling mechanisms 140A and 140B may be configured to form loops by coupling the end of the drawstring to the drawstring itself to form the loop. The coupling mechanisms 140A and 140B may be configured to operate as buttons or fasteners to engage the loops. Other embodiments are also possible.

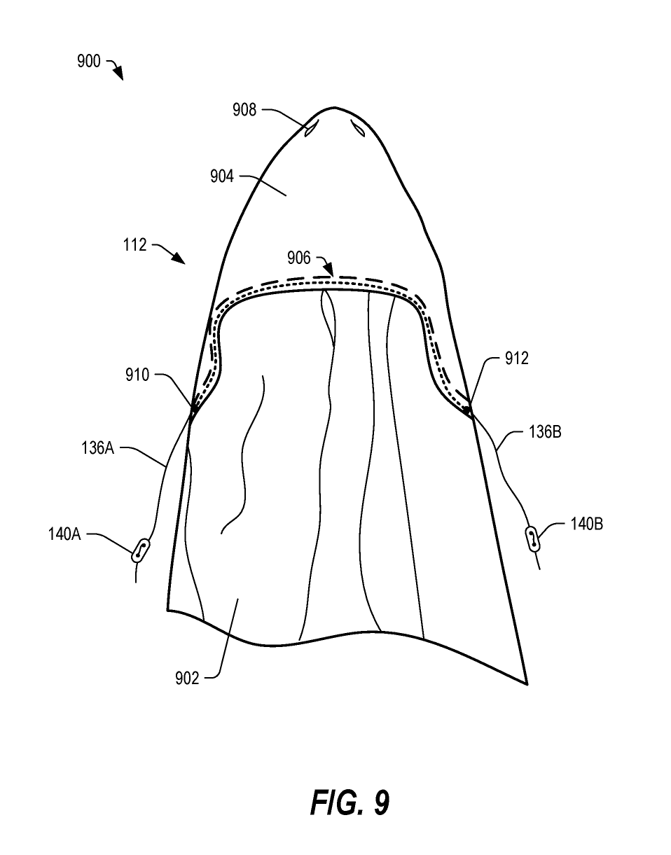

FIG. 9 depicts a front view 900 of a multi-purpose towel 112, in accordance with certain embodiments of the present disclosure. The towel 112 may include a hood portion 904 that defines a channel 906 extending between a first opening 910 and a second opening 912. The drawstring may extend through the channel 906. A first end portion 136A of the drawstring may extend from the first opening 910 and a coupling element 140A may be coupled to the end portion 136A. A second end portion 136B of the drawstring may extend from the second opening 912 and coupling element 140B may be coupled to the second end portion 136B.

In this illustrated example, the hood portion 804 of the multi-purpose towel 112 may include eyelets 908, which can be configured to receive and engage the attachment mechanisms 140A and 140B. In a particular example, the towel 112 may be positioned such that the hood portion 904 is draped over the top portion of a seat. If the seat has a headrest 808, the drawstring may be pulled to tighten the hood portion 104 over the headrest 808. In some embodiments, such as when the seat has no headrest, the drawstring may be pulled and drawn through the eyelets 908 to tighten the towel 112 against the seat and to conform the hood portion 904 of the towel 112 to the top of the seat. Other embodiments are also possible.

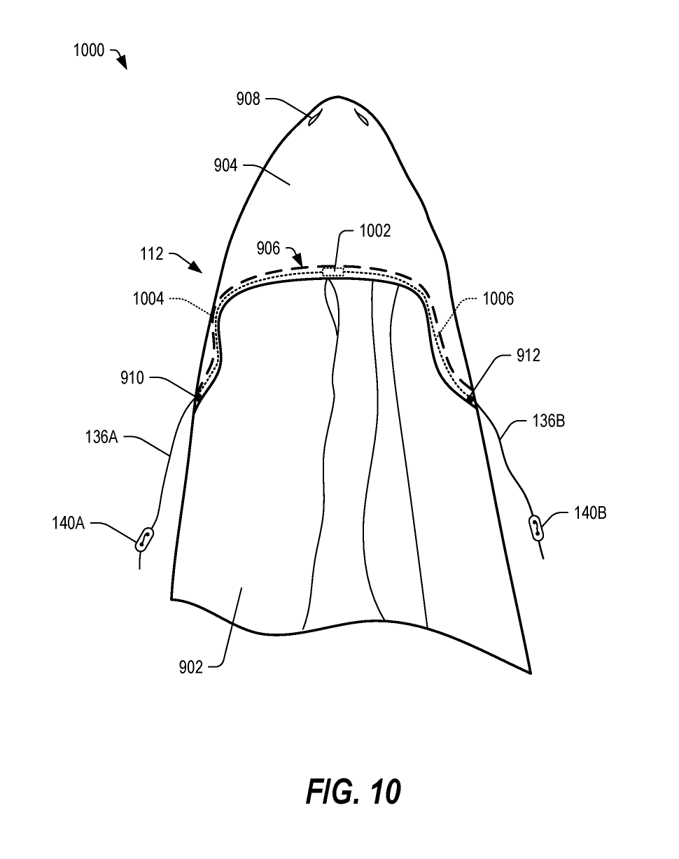

In the illustrated example, the drawstring may be repositioned within the channel 906, making the end portion 136A longer than, shorter than, or the same length as the end portion 136B. In this example, the drawstring may be a single string. In an alternative embodiment, two strings may be used, as described below with respect to FIG. 10.

FIG. 10 depicts a multi-purpose towel 112, in accordance with certain embodiments of the present disclosure. In this example, the drawstring may be replaced with two strings, including a first string 1004 and a second string 1006. The first string 1004 may extend through the first opening 910 and may have a first end portion 136A that includes a coupling mechanism 140A. The other end of the first string 1004 may be attached at an attachment location 1002 within the channel 906. The second string 1006 may be attached at the attachment location 1002 or at another location and may extend through the opening 912. The end portion 1136B of the second string 1006 may also include a coupling element 140B.

In this illustrated example, the hood portion 904 of the multi-purpose towel 112 may include eyelets 908, which can be configured to receive and engage the attachment mechanisms 140A and 140B. In a particular example, the towel 112 may be positioned such that the hood portion 304 is draped over the top portion of a seat. If the seat has a headrest 806, the drawstring may be pulled to tighten the hood portion 904 over the headrest 806. In some embodiments, such as when the seat has no headrest 806, the drawstring may be pulled and drawn through the eyelets 908 to tighten the towel 112 against the seat and to conform the hood portion 904 of the towel 112 to the top of the seat. Other embodiments are also possible.

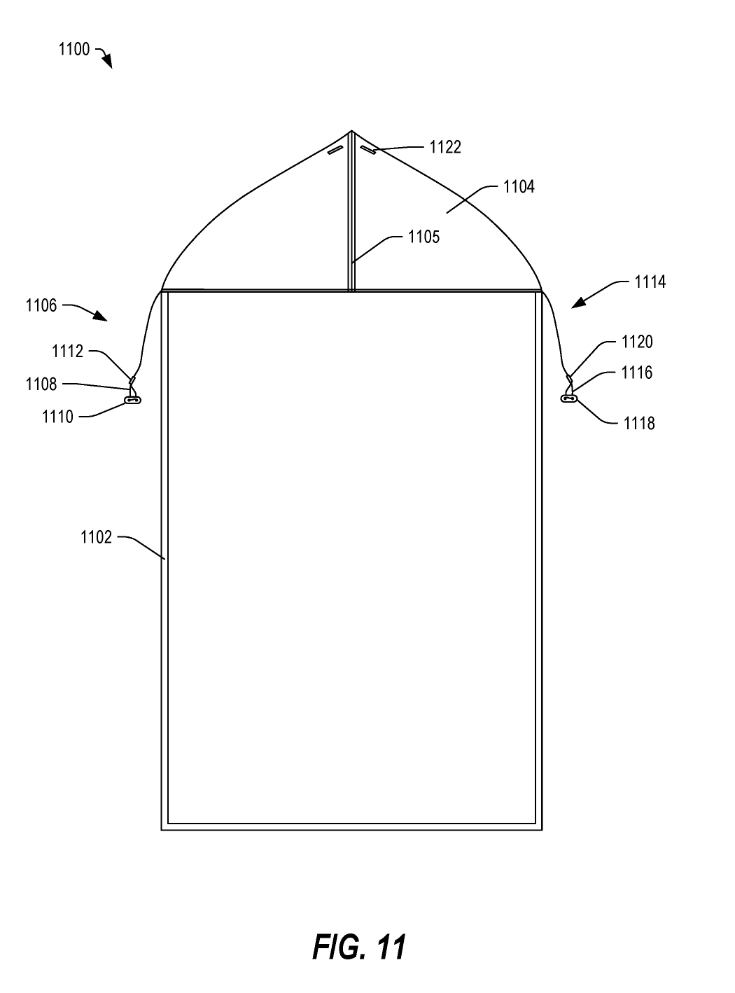

It should be appreciated that the coupling mechanisms 140 in FIGS. 9 and 10 may be implemented using any of the embodiments described above with respect to FIGS. 1-8. Other embodiments are also possible. For example, as described below with respect to FIG. 11, the end of the drawstring may be curved back and coupled to itself to form a loop, which may provide an attachment loop for engaging the coupling mechanism of the other end of the drawstring.

While the above examples have depicted attachment of the multi-purpose towel 100 to a bucket-type of car seat, it should be appreciated that the drawstring(s) and coupling mechanisms enable coupling of the multi-purpose towel to any number of seat types, including bench seats, lounge chairs, pool-side chairs, and the like.

FIG. 11 depicts a multi-purpose towel 1100 including eyelets in a hood portion, in accordance with certain embodiments of the present disclosure. The towel 1100 may include a body portion 1102 and a hood portion 1104. The hood portion 1104 may include a drawstring (having a first portion 1106 and a second portion 1114) that can extend through a channel in the hood portion 1104 or that may be attached to sides of the hood portion 1104. The first portion 1106 of the drawstring may extend from the hood portion 1104 and may include an end loop 1108 that extends through a fastener 1110 and that is fixed using a coupling element 1112. In one example, the coupling element 1112 may be formed by a shrink wrap tube, tape, glue, or another fastener. The second portion 1114 may extend from the hood portion 1104 and may include an end loop 1116 that extends through a fastener 1118 and that is fixed using a coupling element 1120. In the illustrated example, the hood portion 1104 may include eyelets or slots 1122 sized to receive the fasteners 1110 and 1118.

In a particular example, the eyelets 1122 may be formed in the hood portion 904 and aligned approximately with a center of the body portion 1102. In certain embodiments, the eyelets 1122 may be formed at a rear of the hood portion 1104, which would be near the top and back of a user's head when worn as a hood. The eyelets 1122 may be engaged by the fasteners 1110 and 1118 to secure the hood portion 1104 to a seat.

In certain embodiments, the eyelets 901 in FIGS. 9 and 10 and the eyelets 1122 of FIG. 11 may be implemented as an opening having stitching on all sides to provide a button hole or opening to receive the fastener mechanism. In some embodiments, the eyelets may be implemented as a grommet or other type of opening to permit attachment of cords or lines.

In an example, the eyelets 901 or 1122 make it possible to pull the hood portion 1104 down and secure the multi-purpose towel 112 to a seat that does not have a headrest. By pulling the head portion 1104 down and securing the drawstring to the head portion 104 through the eyelets 901 or 1122, the head portion 1104 may be pulled down and secured, proving a tight fit over the top of the seat. An example of the multi-purpose towel coupled to a bench seat with no headrest is described below with respect to FIG. 12.

FIG. 12A illustrates a view 1200 of a multi-purpose towel 1112 coupled to a bench seat 1202, in accordance with certain embodiments of the present disclosure. In the illustrated example, the multi-purpose towel 112 has a generally rectangular shape and includes a body portion 1102 and a hood portion 1104. As with the above-described embodiments, the hood portion 1104 of the towel 112 may be draped over a headrest of the bench seat 1202 and may be secured by a hoop stress created by pulling the ends of the drawstring or drawstrings 1106 and 1114 and securing them using coupling elements 1110 and 1118. The body portion 1102 of the multi-purpose towel 112 may be draped across the selected seat.

In some embodiments, a particular seat or chair may be longer than the multi-purpose towel 112. In an example, multiple multi-purpose towels may be coupled to one another using the coupling mechanisms 1110 and 1118 to secure a first multi-purpose towel to a second multi-purpose towel, and so on. Any number of multi-purpose towels 112 may be coupled together to achieve a desired configuration. Other embodiments are also possible.

In the illustrated example, the hood portion 1104 of the multi-purpose towel 1102 may be draped over the top of the bench seat 1202 and the drawstring 1106 may be pulled tight and threaded through the eyelets 1122 to secure the hood portion 1104 over the back of the seat 1202. By threading the drawstring 1106 and 1114 through the eyelets 1122, the towel 112 may be pulled tightly across a top of the bench seat 1202.

FIG. 12B depicts a side view 1210 the multi-purpose towel 1102 of FIG. 11 folded in half lengthwise and depicting one of the eyelets 1122, in accordance with certain embodiments of the present disclosure. In this example, the hood portion 1104 extends from the body portion and then tapers toward the front. A top of the hood portion 1104 may be sown along a seam 1105.

In the illustrated example, only the drawstring 1106 is shown, but it should be appreciated that a second drawstring 1114 (or second portion of the same drawstring) is present on the other side of the towel 112. The drawstring 1106 extends through a fastener 1110 and curls back onto itself, fastened by a coupling element 1112 and forming a loop 1108.

FIG. 12C depicts a view 1220 of a fastener 1110 coupled to a loop 908 formed from a first portion 106 of a drawstring, in accordance with certain embodiments of the present disclosure. The coupling element 112 can be configured to secure an end of the drawstring to itself to secure the loop 1108. The coupling element 1112 may be formed from an adhesive or from a heat shrink type of material, which secures the end of the drawstring.

The fastener 1110 may be implemented as a button or post that can be coupled to the drawstring and that can fit through the eyelets 1122 in the hood portion 1104. While the illustrated examples of FIGS. 1-12C have shown a fastener 1110 with two holes, it should be understood that the fastener 1110 may have a single hole or opening or may be attached to the drawstring 1106 in another manner. Other embodiments are also possible.

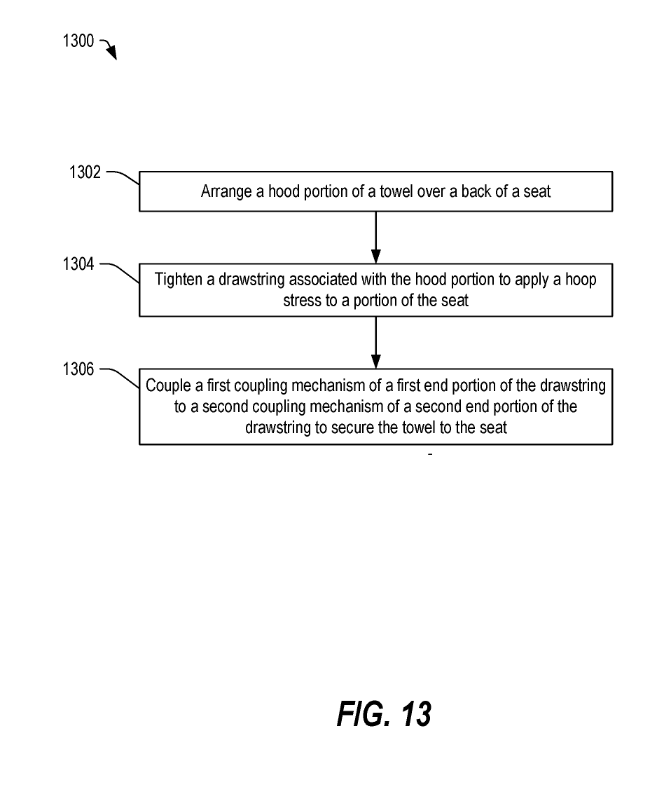

FIG. 13 is a flow diagram of a method 1300 of coupling a multi-purpose towel to a seat without a headrest, in accordance with certain embodiments of the present disclosure. At 1302, the method 1300 may include arranging a hood portion of a towel over a back of a seat. In an example, the hood portion 1104 may be positioned over a headrest of a car seat or may be stretched over the end portion of a lounge chair. Other embodiments are also possible.

At 1304, the method 1300 may include tightening a drawstring associated with the hood portion to apply a hoop stress to a portion of the seat. In an example, the drawstring may be tightened to draw the hood around the head rest or the end of the lounge chair.

At 1306, the method 1300 may include coupling a first coupling mechanism of a first end portion of the drawstring to a second coupling mechanism of a second end portion of the drawstring to secure the towel to the seat. In an embodiment, the first coupling mechanism may be coupled to the second coupling mechanism by feeding the first coupling mechanism through a loop formed between a portion of the second end portion of the drawstring and a tab of the second coupling mechanism, as shown in FIG. 5B, for example.

In another embodiment, the first coupling mechanism may be coupled to the second coupling mechanism by aligning a first magnet of the first coupling mechanism to a second magnet of the second coupling mechanism. In another embodiment, the first coupling mechanism may include a magnet and the second coupling mechanism can include a metal element, which may be aligned to the magnet to couple the first coupling mechanism and the second coupling mechanism.

In still another embodiment, the first coupling mechanism may include a clip or other structure configured to mate with a corresponding structure of the second coupling mechanism. Other coupling mechanisms may also be possible.

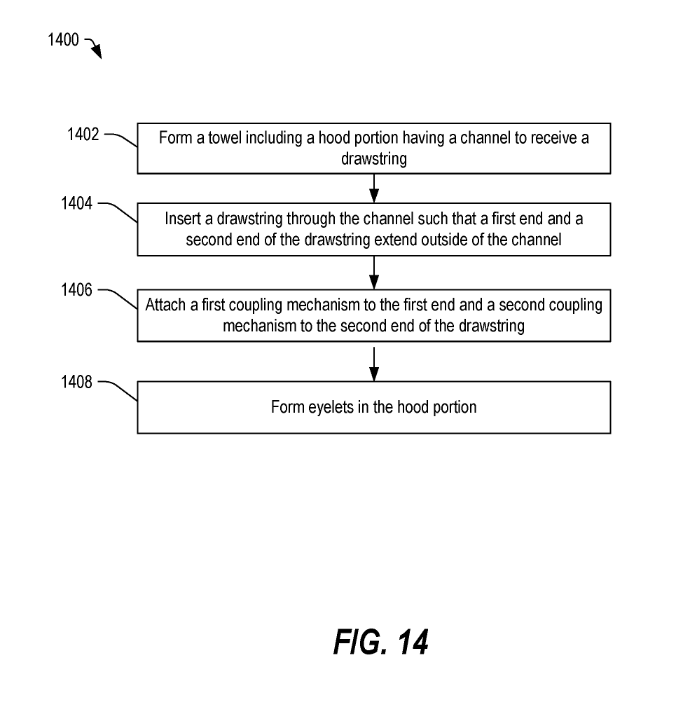

FIG. 14 depicts a flow diagram of a method 1400 of forming a multi-purpose towel, in accordance with certain embodiments of the present disclosure. At 1402, the method 1400 may include forming a towel including a hood portion having a channel to receive a drawstring. In some embodiments, a hood portion may be sewn onto a towel. In some embodiments, the channel may be formed by sowing a seam defining a channel along the peripheral edge of the hood portion.

At 1404, the method 1400 may include a drawstring through the channel such that a first end and a second end of the drawstring may extend outside of the channel. In an example the first end may extend through a first opening 706 and the second end may extend through the second opening 906.

At 1406, the method 1400 may include attaching a first coupling mechanism to the first end and a second coupling mechanism to the second end of the drawstring. The first and second coupling mechanism may be any of the embodiments described above with respect to FIGS. 1-12C.

At 1408, the method 1400 can include forming eyelets in the hood portion of the towel. The eyelets may be formed by cutting a small slit or opening in the fabric and stitching around the opening. In some embodiments, a grommet or other device may be used to form and secure the opening or slit, which is configured to engage the coupling mechanism or fastener at the end of the drawstring.

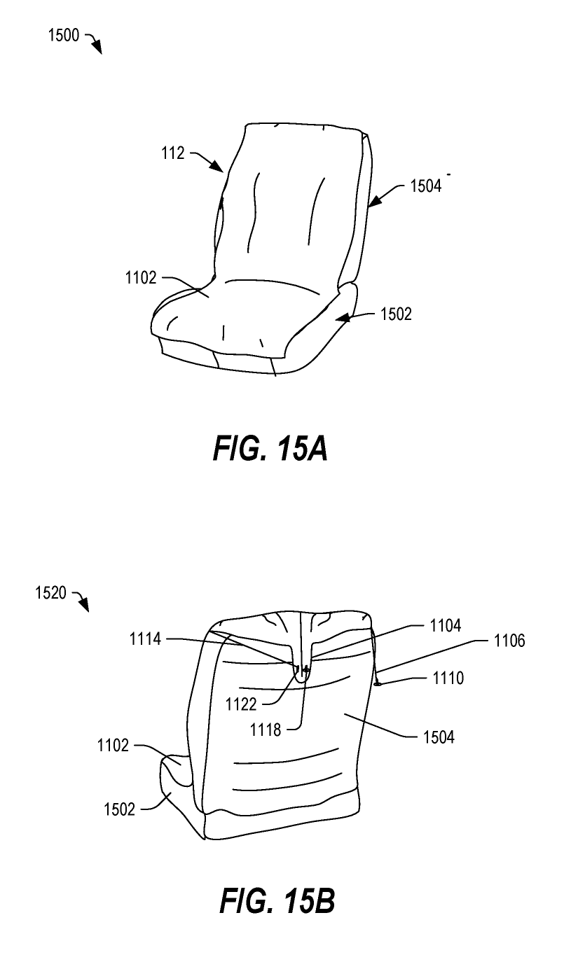

FIG. 15A depicts a front perspective view 1500 of a multi-purpose towel 112 coupled to a seat 1502 without a head rest, in accordance with certain embodiments of the present disclosure. As discussed above and depicted in FIG. 15B, the towel 112 includes a body portion 1102 and a hood portion 1104. The second portion 1114 of the drawstring and its associated coupling mechanism or fastener 1118 may be threaded through the eyelets 1122.

FIG. 15B depicts a rear perspective view 1520 of the seat 1102 and multi-purpose towel 112 of FIG. 15A. The backrest 1504 of the seat 1502 does not include a headrest. The hood portion 1104 may be pulled down behind the backrest 1504 and the second portion 1114 of the drawstring and its associated coupling mechanism or fastener 1118 may be threaded through the eyelets 1122. In this example, the first portion 1106 of the drawstring and its associated coupling mechanism or fastener 1110 are not yet threaded through the eyelets 1122.

In some embodiments, the first and second portions 1106 and 1114 of the drawstring may be formed from an elastic material that may pull the hood portion 1104 taught. In certain examples, by looping the drawstrings 1106 and 1114 through the eyelets 1122, the drawstrings 1106 and 1114 may hold the hood portion 1104 down and secure the towel 112 tightly over the backrest 1504. Other embodiments are also possible.

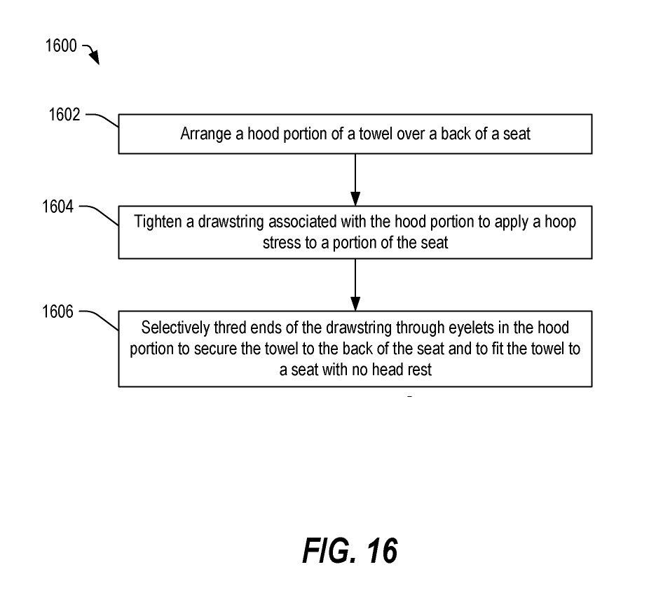

FIG. 16 depicts a flow diagram of a method 1600 of coupling a multi-purpose towel to a seat without a head rest, in accordance with certain embodiments of the present disclosure. At 1602, the method 1600 may include arranging a hood portion of the towel over a back of a seat. The body portion of the towel may be draped over the front portion of the seat.

At 1604, the method 1600 can include tightening a drawstring associated with the hood portion to apply a hoop stress to a portion of the seat. In some embodiments, the drawstring may be formed from an elastic material that retracts to apply the hoop stress. In other embodiments, the drawstring may be pulled tightly and secured in tension to maintain the hoop stress.

At 1606, the method 1600 may include selectively threading ends of the drawstring through eyelets in the hood portion to secure the towel to the back of the seat and to fit the towel to a seat with no headrest. The eyelets may be used to pull the hood portion down behind the seat. Other embodiments are also possible.

In conjunction with the apparatuses, devices, and methods described above with respect to FIGS. 1-14, a multi-purpose towel is disclosed that may include a hood portion and a body portion. The hood portion may be configured to secure one or more drawstrings. In an example, the hood portion may define a channel configured to secure a drawstring. In some embodiments, the drawstring may be replaced with first and second drawstrings, which may be sewn at a first end within the channel and which may include end portions that extend outside of the channel. A first end portion may be coupled to a first coupling mechanism and a second end portion may be coupled to a second coupling mechanism.

In some embodiments, the first coupling mechanism and the second coupling mechanism may each include a tab portion configured to attach to an end portion of the drawstring. The tab and a portion of the drawstring may cooperate to form a loop configured to secure a tab associated with the other end portion. In some embodiments, the coupling mechanism may include a magnet, a metallic element, an attachment element and corresponding structure, or any combination thereof.

In still other embodiments, eyelets may be formed in at least a hood portion of the multi-purpose towel. The coupling mechanism may be threaded through the eyelets (like a button) to secure the towel to a seat. By pulling the hood down behind the seat and threading the coupling mechanisms through the eyelets, the towel may be secured to a seat, providing a form-fitted seat cover configured to fit tightly to seats having headrests as well as seats that do not have headrests. Other embodiments are also possible.

Although the present invention has been described with reference to preferred embodiments, workers skilled in the art will recognize that changes may be made in form and detail without departing from the scope of the invention.

What is claimed is:

1. A multi-purpose towel comprising:
a body portion including an absorbent material;
a hood portion coupled to the body portion and defining a channel;
at least one drawstring extending through the channel and including a first end portion and a second end portion; and
a first coupling mechanism coupled to the first end portion and a second coupling mechanism coupled to the second end portion.

2. The multi-purpose towel of claim 1, further comprising one or more eyelets formed in the hood portion and configured to engage at least one of the first and second coupling mechanisms.

3. The multi-purpose towel of claim 1, wherein each of the first coupling mechanism and the second coupling mechanism comprises:
a tab forming a substrate; and
at least one opening configured to receive an end portion of the drawstring.

4. The multi-purpose towel of claim 3, wherein the tab is formed from at least one of metal, wood, plastic, and closed-cell resin material.

5. The multi-purpose towel of claim 3, further comprising at least one magnet coupled to the tab.

6. The multi-purpose towel of claim 4, further comprising a metallic element coupled to the tab at a first location, and wherein the at least one magnet is coupled to the tab at a second location spaced apart from the first location.

7. The multi-purpose towel of claim 3, wherein the tab and a portion of the end portion of the drawstring cooperate to form a cinch.

8. The multi-purpose towel of claim 1, wherein the hood portion is sized to fit over at least one of a headrest and an end portion of a seat.

9. The multi-purpose towel of claim 1, wherein the hood portion is formed from an absorbent material.

10. The multi-purpose towel of claim 1, wherein the body portion and the hood portion are formed from different combinations of materials.

11. A towel comprising:
a body portion including an absorbent material;
a hood portion coupled to the body portion and including at least one eyelet;
at least one drawstring coupled to the hood portion, the at least one drawstring including a first end portion having a first coupling mechanism and including a second end portion having a second coupling mechanism, the first and second coupling mechanisms configured to engage the at least one eyelet.

12. The towel of claim 11, wherein each of the first coupling mechanism and the second coupling mechanism comprises:
a tab forming a substrate; and
at least one opening configured to receive an end portion of the drawstring.

13. The towel of claim 12, wherein the tab is formed from at least one of metal, wood, plastic, and closed-cell resin material.

14. The towel of claim 11, wherein the at least one drawstring is formed from an elastic material.

15. The towel of claim 11, wherein the first coupling mechanism and the second coupling mechanism comprise buttons.

16. The towel of claim 11, wherein the hood portion is configured to fit over a headrest of a seat.

17. A towel comprising:
a body portion including an absorbent material;
a hood portion coupled to the body portion and including at least one eyelet;
at least one drawstring including:
a first end portion having a first coupling mechanism;
a second end portion having a second coupling mechanism; and
wherein the first and second coupling mechanisms are configured to engage the at least one eyelet.

18. The towel of claim 17, wherein the hood portion includes:
a channel configured to receive the at least one drawstring;
a first opening on a first end of the channel through which the first end portion extends; and
a second opening on a second end of the channel through which the second end portion extends.

19. The towel of claim 17, wherein the at least one drawstring is formed from an elastic material.

20. The towel of claim 17, wherein the first coupling mechanism and the second coupling mechanism comprise buttons.
